(19) United States
(12) Patent Application Publication
(10) Pub. No.: US 2015/0254527 A1
(43) Pub. Date: Sep. 10, 2015

(54) METHODS FOR 3D OBJECT RECOGNITION AND REGISTRATION

(71) Applicant: Kabushiki Kaisha Toshiba, Minato-ku (JP)

(72) Inventors: Minh-Tri Pham, Cambridge (GB); Frank Perbet, Cambridge (GB); Bjorn Dietmar, Rafael Stenger, Cambridge (GB); Riccardo Gherardi, Cambridge (GB); Oliver Woodford, Cambridge (GB); Sam Johnson, Cambridge (GB); Roberto Cipolla, Cambridge (GB); Stephan Liwicki, Cambridge (GB)

(73) Assignee: Kabushiki Kaisha Toshiba, Minato-ku (JP)

(21) Appl. No.: 14/468,733

(22) Filed: Aug. 26, 2014

(30) Foreign Application Priority Data
Mar. 4, 2014 (GB) 1403826.9

(51) Int. Cl. G06K 9/62; G06K 9/52

(52) U.S. Cl. CPC G06K 9/6215; G06K 9/52

(57) ABSTRACT

A method for comparing a plurality of objects, the method comprising representing at least one feature of each object as a 3D ball representation, the radius of each ball representing the scale of the feature in the with respect to the frame of the object, the position of each ball representing the translation the feature in the frame of the object, the method further comprising comparing the objects by comparing the scale and translation as represented by the 3D balls to determine similarity between objects and their poses.

### CROSS-REFERENCE TO RELATED APPLICATIONS

This application is based upon and claims the benefit of priority from prior United Kingdom Application number 1403826.9 filed on Mar. 4, 2014, the entire contents of which are incorporated herein by reference.

### FIELD

Embodiments of the present invention as described herein are generally concerned with the field of object registration and recognition.

### BACKGROUND

Many computer vision and image processing applications require the ability to recognise and register objects from a 3D image.

Such applications often recognise key features in the image and express these features in a mathematical form. Predictions of the object and its pose, termed votes, can then be generated and a selection between different votes is made.

### BRIEF DESCRIPTION OF THE DRAWINGS

FIG. 1 is a schematic of an apparatus used for capturing a 3-D image;

FIG. 2 is an image demonstrating a feature;

FIG. 3(a) is a point cloud generated from a captured 3-D image of an object and FIG. 3(b) shows the image of FIG. 3(a) with the extracted features;

FIG. 4 is a flow chart showing how votes are generated;

FIG. 5 is a flow chart showing the construction of a hash table from training data;

FIG. 6 is a flow chart showing the steps for selecting a vote using the hash table;

FIG. 7 is a flow chart showing a variation on the flow chart of FIG. 6 where rotation of the poses is also considered;

FIG. 8 is a plot showing a 2D method for comparing distances between points; and

FIG. 9 is a plot showing the results of a 3D method for comparing distances between points;

FIGS. 10(a) to 10(d) are plots showing the performance of different measures for comparing arrays of rotations for different distributions of the rotations;

FIG. 11 is a flow chart showing the construction of a vantage point search tree from training data

FIG. 12 is a flow chart showing the steps for selecting a vote using the search tree of FIG. 11; and

FIG. 13 is a schematic of a search tree of the type used in FIGS. 11 and 12.

### DETAILED DESCRIPTION OF THE DRAWINGS

According to one embodiment, a method for comparing a plurality of image data relating to objects is provided, the method comprising representing at least one feature of each object as a 3D ball representation, the radius of each ball representing the scale of the feature with respect to the frame of the object, the position of each ball representing the translation the feature in the frame of the object, the method further comprising comparing the objects by comparing the scale and translation as represented by the 3D balls to determine similarity between objects and their poses.

The frame of the object is defined as a local coordinate system of the object. In an example, the origin of the local coordinate system is at the center of the object, the three axes are aligned to a pre-defined 3D orientation of the object, and one unit length of an axis corresponds to the size of the object.

In a further embodiment, the 3D ball representations further comprise information about the rotation of the feature with respect to the frame of the object and wherein comparing the object comprises comparing the scale, translation and rotation as defined by the 3D ball representations. The 3D orientation is assigned to a 3D ball which will be referred to as a 3D ball with 3D orientation, or a 3D oriented ball. Technically, a 3D ball is represented by a direct dilatation and a 3D oriented ball is represented by a direct similarity.

In an embodiment, comparing the scale and translation comprises comparing a feature of a first object with a feature of a second object to be compared with the first object using a hash table, said hash table comprising entries relating to the scale and translation of the features of the second object hashed using a hash function relating to the scale and translation components, the method further comprising searching the hash table to obtain a match of a feature from the first object with that of the second object.

In the above embodiment, the hash function may be described by:

h(X):=η∘Φ(X_{D}).

where h(X) is the hash function of direct similarity X,

$${X}_{D} := [ \begin{matrix}{X}_{s} & {X}_{t} \\ 0 & 1\end{matrix} ]$$

is the dilatation part of a direct similarity X where Xₛ is the scale part of direct similarity X and Xₜ is the translation part of direct similarity X,

Φ(X_{D}):=(lnXₛ,Xₜ^{T}/Xₛ)^{t}; and

η is a quantizer.

In this embodiment, the hash table may comprise entries for all rotations for each scale and translation component.

The hash table may be used to compare features using the 3D ball representations which do not contain rotation information and those which comprise information about the rotation of the feature with respect to the frame of the object and wherein comparing the object comprises comparing the scale, translation and rotation as defined by the 3D ball representations, the method further comprising comparing the rotations stored in each hash table entry when a match has been achieved for scale and translation components, to compare the rotations of the feature of the first object with that of the second object.

Many different measures can be used for comparing the rotations in 3D. In an embodiment, the rotations are compared using a cosine based distance in 3D. For example, the cosine based distance may be expressed as:

$${d ( {r}_{a} , {r}_{b} )}^{2} := 1 - {\sum }_{j = 1}^{N} ( \frac{1 - {v}_{a , j} \cdot {v}_{b , j}}{2} ) \frac{cos ( {α}_{a , j} - {α}_{b , j} )}{N} - {\sum }_{j = 1}^{N} ( \frac{1 + {v}_{a , j} \cdot {v}_{b , j}}{2} ) \frac{cos ( {α}_{a , j} - {α}_{b , j} )}{N} .$$

Where rₐ=(νₐ, αₐ) and r_{b}=(ν_{b}, α_{b}) are arrays for 3D rotations represented in the axis-angle representation. νₐⱼ and αₐⱼ, respectively denote the rotation axis and the rotation angle of the j^{th} component of the array rₐ. ν_{bj} and α_{bj}, respectively denote the rotation axis and the rotation angle of the j^{th} component of the array r_{b}.

The above embodiment has suggested the use of a hash table to search for the nearest features between two objects to be compared. However, in an embodiment, this may be achieved by comparing a feature of a first object with a feature of a second object to be compared with the first object using a search tree, said search tree comprising entries representing the scale and translation components of features in the second object, the scale and translation components being compared using a closed-form formulae.

Here, the search tree is used to locate nearest neighbours between the features of the first object and the second object. The scale and translation components may be compared by measuring the Poincare distance between the two features. For example, the distance measure may be expressed as:

$${d}_{1} ( x , y ) = {cosh}^{- 1} ( 1 + \frac{{( {r}_{x} - {r}_{y} )}^{2} + \vert \vert {c}_{x} - {c}_{y} {\vert \vert}^{2}}{2 {r}_{x} {r}_{y}} ) ,$$

Where d₁(x,y) represents the distance between two balls x and y that are represented by x=(rₓ; cₓ) and y=(r_{y}; c_{y}) where rₓ; r_{y}>0 denote the radii, cₓ, c_{y}∈ [symbol] ³ denote the ball centres in 3D and cosh( )is the hyperbolic cosine function.

The search tree may also be used when the 3D ball representations further comprise information about the rotation of the feature with respect to the frame of the object and wherein comparing the object comprises comparing the scale, translation and rotation as defined by the 3D ball representations using the formulae:

d₂(x,y)=\sqrt{a₁d₁(x,y)²+a₂∥Rₓ−R_{y}∥_{F}²,}

where d₂(x,y) represents the distance between two balls x and y as defined above and the two balls x and y are associated with two 3D orientations, represented as two 3-by-3 rotation matrices Rₓ, R_{y}∈SO(3), the term a₂∥Rₓ−R_{y}∥_{F}² represents a distance function between two 3D orientations via the Frobenius norm, and coefficients a₁; a₂>0. In a further embodiment, the distance function between two 3D orientations is the cosine based distance d(rₐ, r_{b}) above.

In an embodiment, a method for object recognition is provided, the method comprising:
receiving a plurality of votes, wherein each vote corresponds to a prediction of an objects pose and position;
for each vote, assigning 3D ball representations to features of the object, wherein the radius of each ball represents the scale of the feature in the with respect to the frame of the object, the position of each ball representing the translation the feature in the frame of the object,
determining the vote that provides the best match by comparing the features as represented by the 3D ball representations for each vote with a database of 3D representations of features for a plurality of objects and poses, wherein comparing the features comprises comparing the scale and translation as represented by the 3D balls; and
selecting the vote with the greatest number of features that match an object and pose in said database.

In the above embodiment, the 3D ball representations are assigned to the votes and the objects and poses in the database further comprise information about the rotation of the feature with respect to the frame of the object and wherein determining the vote comprises comparing the scale, translation and rotation as defined by the 3D ball representations.

In the above method, receiving a plurality of votes may comprise:
obtaining 3D image data of an object;
identifying features of said object and assigning a description to each feature, wherein each description comprises an indication of the characteristics of the feature to which it relates;
comparing said features with a database of objects, wherein said database of objects comprises descriptions of features of known objects; and
generating votes by selecting objects whose features match at least one feature identified from the 3D image data.

In a further embodiment, a method of registering an object in a scene may be provided, the method comprising:
obtaining 3D data of the object to be registered;
obtaining 3D data of the scene;
extracting features from the object to be registered and extracting features from the scene to determine a plurality of votes, wherein each vote corresponds to a prediction of an object's pose and position in the scene, and comparing the object to be registered with the votes using a method as described above to identify the presence and pose of the object to be registered.

In a yet further embodiment, an apparatus for comparing a plurality of objects is provided,
the apparatus comprising a memory configured to store 3D data of the objects comprising at least one feature of each object as a 3D ball representation, the radius of each ball representing the scale of the feature in the with respect to the frame of the object, the position of each ball representing the translation the feature in the frame of the object,
the apparatus further comprising a processor configured to compare the objects by comparing the scale and translation as represented by the 3D balls to determine similarity between objects and their poses.

Since the embodiments of the present invention can be implemented by software, embodiments of the present invention encompass computer code provided to a general purpose computer on any suitable carrier medium. The carrier medium can comprise any storage medium such as a floppy disk, a CD ROM, a magnetic device or a programmable memory device, or any transient medium such as any signal e.g. an electrical, optical or microwave signal.

A system and method in accordance with a first embodiment will now be described.

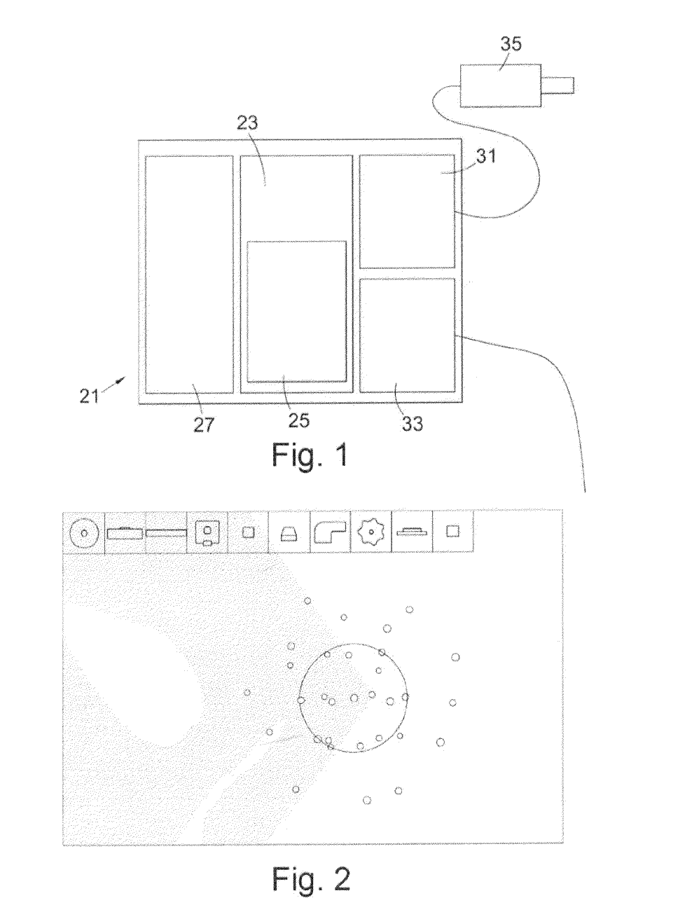

FIG. 1 shows a possible system which can be used to capture the 3-D data. The system basically comprises a camera 35, an analysis unit 21 and a display (not shown).

In an embodiment, the camera 35 is a standard video camera and can be moved by a user. In operation, the camera 35 is freely moved around an object which is to be imaged. The camera may be simply handheld. However, in further embodiments, the camera is mounted on a tripod or other mechanical support device. A 3D point cloud may then be constructed using the 2D images collected at various camera poses. In other embodiments a 3D camera or other depth sensor may be used, for example a stereo camera comprising a plurality of fixed apart apertures or a camera which is capable of projecting a pattern onto said object, LIDAR sensors and time of flight sensors. Medical scanners such as CAT scanners and MRI scanners may be used to provide the data. Methods for generating a 3D point cloud from these types of cameras and scanners are known and will not be discussed further here.

The analysis unit 21 comprises a section for receiving camera data from camera 35. The analysis unit 21 comprises a processor 23 which executes a program 25. Analysis unit 21 further comprises storage 27. The storage 27 stores data which is used by program 25 to analyse the data received from the camera 35. The analysis unit 21 further comprises an input module 31 and an output module 33. The input module 31 is connected to camera 35. The input module 31 may simply receive data directly from the camera 35 or alternatively, the input module 31 may receive camera data from an external storage medium or a network.

In use, the analysis unit 21 receives camera data through input module 31. The program 25 executed on processor 23 analyses the camera data using data stored in the storage 27 to produce 3D data and recognise the objects and their poses. The data is output via the output module 35 which may be connected to a display (not shown) or other output device either local or networked.

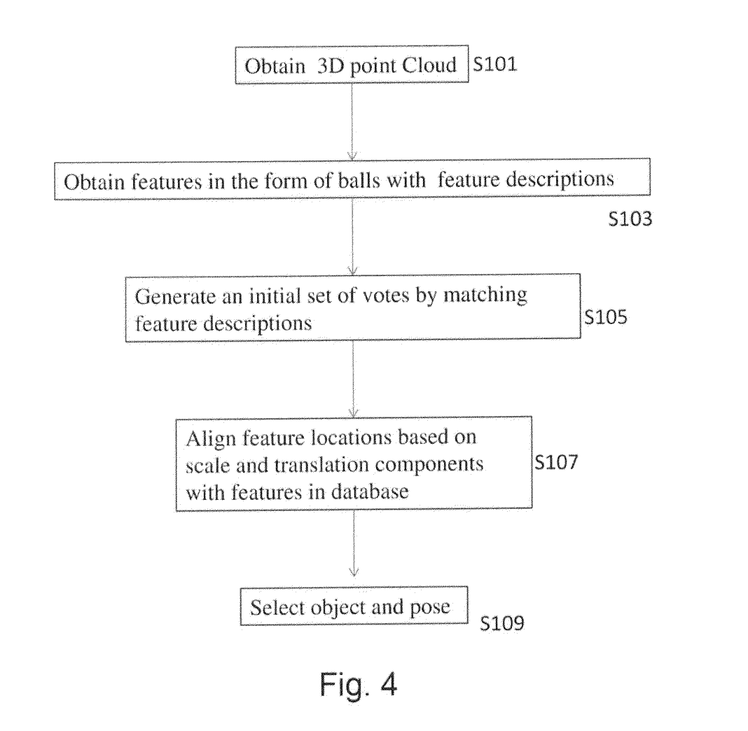

In FIG. 4, the 3D point cloud of the scene is obtained in step S101. From the 3D point cloud, local features in the form of 3D balls together with their descriptions are extracted from the point cloud of the input scene in step S103. This may be achieved using a known multi-scale keypoint detector like SURF-3D or ISS. FIG. 2 shows an example of such an extracted feature. The feature corresponds to a corner of the object and can be described using a descriptor vector or the like, for example a spin-image descriptor or a descriptor that samples a set number of points close to the origin of the feature.

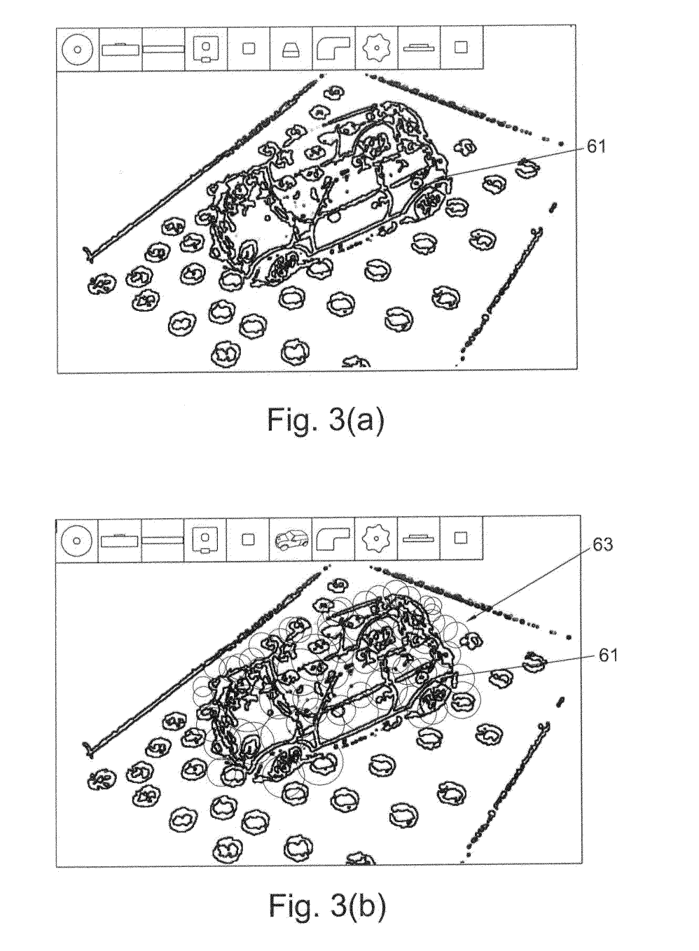

FIG. 3(a) shows a point cloud of an object 61 and FIG. 3(b) shows the point cloud of the object 61 after feature extraction, the feature being shown as circles (63).

At test time, features extracted from the scene are matched with previously extracted features from training data by comparing their descriptions and generating an initial set of votes in step S105. The votes are hypotheses predicting the object identity along with its pose, consisting of a position and an orientation and additionally a scale if scales are unknown. The best vote is then selected and returned as final prediction in step S109.

In an embodiment, step S107 of aligning the feature locations is executed using a hash table.

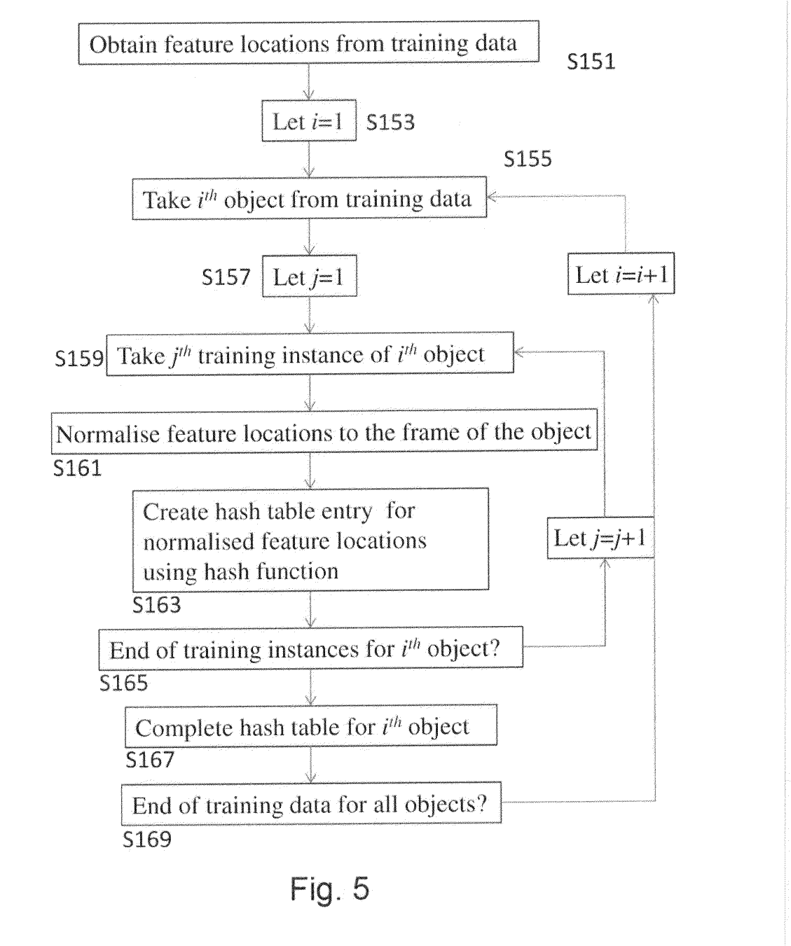

FIG. 5 is a flow diagram showing the steps for constructing the hash table from the training data.

In this embodiment, the more general case of 3D recognition in which object scale varies will be considered and object poses and feature locations are treated as direct similarities. For notational convenience, Xₛ, X_{R} and Xₜ will denote the scale, rotation and translation part respectively of a direct similarity X.

The steps of the flow diagram of FIG. 5 will generally be performed off-line.

In the offline phase training data is collected for each object type to be recognized. In step S151, all feature locations that occur in the training data are collected. The features extracted from the training data and are processed for each object (i) and each training instance (j) of that object. In step S153 the object count (i) is set to 1 and processing of the i^{th} object starts in step S155. Next, the training instance count (j) for that object is set to 1 and processing of the j^{th} training instance begins in step S159.

Next, the selected features are normalized via left-multiplication with their corresponding object pose's inverse. This brings the features to be normalised to the object space in step S161.

Next, a hash table is created such that all normalised locations of object i are stored in a single hash table Hᵢ in which hash keys are computed based on the scale and translation components. The design of the hash function h(•) is detailed below. The value of a hash entry is the set of rotations of all normalized locations hashed to it.

The scale and translation parts of a direct similarity forms a transformation called (direct) dilatation, in the space:

$$𝒟𝒯 ( 3 ) := \{ [ \begin{matrix}s & t \\ 0 & 1\end{matrix} ] , s ∈ {ℛ}_{+} , t ∈ {ℛ}^{3} \} . \\ Where \text{:} \\ {X}_{D} := [ \begin{matrix}{X}_{s} & {X}_{t} \\ 0 & 1\end{matrix} ] \qquad ( 1 )$$

the dilatation part of a direct similarity X. Given a query direct similarity X, X_{D} is converted into a 4D point via a map Φ:DT(3)→ [symbol] :

Φ(X_{D}):=(lnXₛ,Xₜ^{T}/Xₛ)^{T}. (2)

Then, the 4D point is quantized into a 4D integer vector, i.e. a hash key, via a quantizer η: [symbol] → [symbol] ⁴:

$$η ( x ) := {( ⌊ \frac{{x}_{1}}{{σ}_{s}} ⌋ , ⌊ \frac{{x}_{2}}{{σ}_{t}} ⌋ , ⌊ \frac{{x}_{3}}{{σ}_{t}} ⌋ , ⌊ \frac{{x}_{4}}{{σ}_{t}} ⌋ )}^{T} , \qquad ( 3 )$$

where σₛ and σₜ are parameters that enable making tradeoffs between scale and translation, and operator └·┘ finds the integer value of a real number. Thus, the hash function h(•) is defined as

h(X):=η∘Φ(X_{D}).

An efficient hash table should ensure that every hash entry be accessed with roughly the same probability, so that collisions are minimized. To achieve this, Φ(•) is created so that the following lemma holds.

Lemma 1. The Euclidean volume element of [symbol] ⁴ is pulled back via Φ(•) to a left-invariant 4-form on DT(3).

Proof. Denote by

D(x):=dx₁dx₂dx₃dx₄

the Euclidean volume element at X:=Φ⁻¹(x). To prove the lemma, it is sufficient to show that for all Y∈DT(3) and x∈ [symbol] ⁴:

D(x)=D(Φ(YΦ⁻¹(x))). (4)

Let y:=Φ(Y). By substituting (2) into (4) yields:

$$\begin{matrix}φ ( Y {φ}^{- 1} ( x ) ) & ( 5 ) \\ \begin{matrix} = φ ( [ \begin{matrix}{e}^{{y}_{1} + {x}_{1}} & {e}^{{y}_{1} + {x}_{1}} {x}_{2 : 4} + {e}^{{y}_{1}} {y}_{2 : 4} \\ 0 & 1\end{matrix} ] ) \\ = {( {y}_{1} + {x}_{1} , {x}_{2 : 4}^{T} + {e}^{- {x}_{1}} {y}_{2 : 4}^{T} )}^{T} . ( 7 )\end{matrix} & ( 6 )\end{matrix}$$

It can be seen from (7) that the Jacobian determinant of (5) is equal to 1. Therefore,

D(Φ(YΦ⁻¹(x)))=|1|dx₁dx₂dx₃dx₄=D(x).

Lemma 1 implies that if the dilatations are uniformly distributed in DT(3), i.e. distributed by a (left-) Haar measure, their coordinates via Φ(•) are uniformly distributed in [symbol] ⁴ , and vice versa. Combining this fact with the fact that the quantizer η, partitions [symbol] ⁴ into cells with equal volumes, it can be deduced that if the dilatations are uniformly distributed, their hash keys are uniformly distributed.

Algorithm 1 below shows the off-line training phase as described above with reference to FIG. 5.

Algorithm 1 Offline phase: creating hash tables

| Input: training feature locations ℑ and poses C | |
|---|---|
| 1: | for all object i: |
| 2: | Create hash table Hᵢ. |
| 3: | for all training instance j of the object: |
| 4: | for all feature k of the training instance: |
| 5: | X ← C_{i,j}⁻¹ ℑ_{i,j,k}. |
| 6: | Find/insert hash entry V ← Hᵢ (h(X)). |
| 7: | V ← V ∪ {X_{R}}. |
| 8: | Return H. |

Here, ℑ and C are multi-index lists such that ℑ_{i,j,k} denotes the i^{th} object's training instance's k^{th} feature location, and c_{i,j} denotes the i^{th} object's j^{th} training instance's pose.

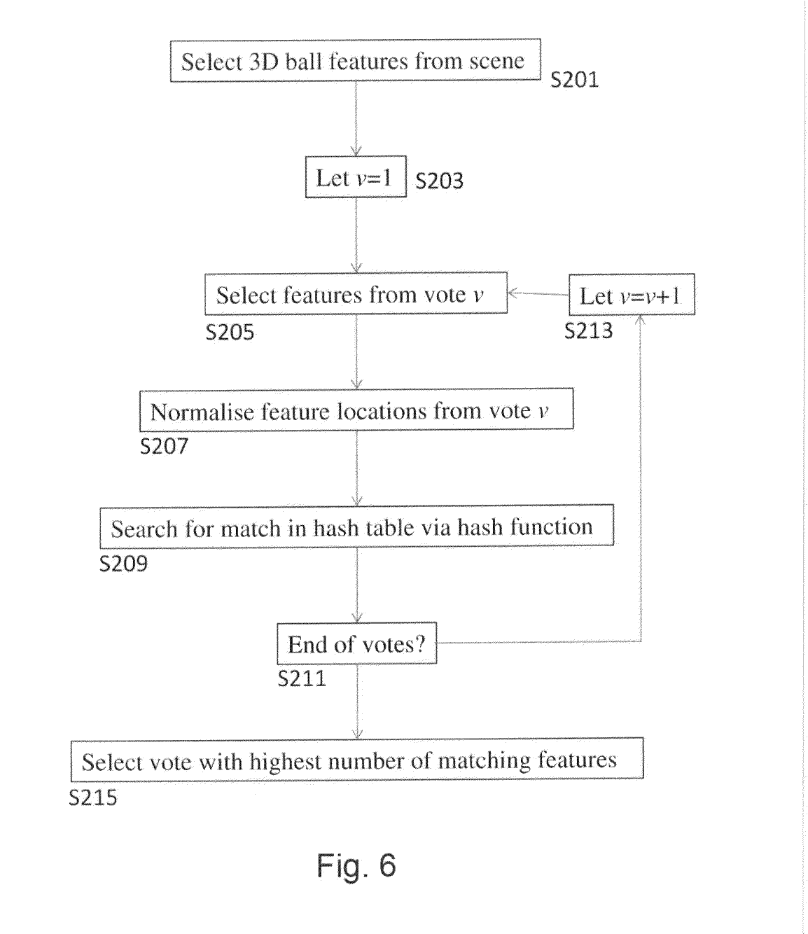

FIG. 6 is a flow diagram showing the steps of the matching features from a scene using the hash table as described with reference to FIG. 5. The same feature detector should be used in the off-line training phase and the on-line phase.

In step S201, the search space is restricted to the 3D ball features are selected from the scene. Each ball feature is assigned to a vote which is prediction of the objects identity and pose. In step S203, the vote counter ν is assigned to 1. In step S205, features from vote ν are selected.

In step S207, the scene feature locations denoted by S for that vote are left multiplied with the inverse of the vote's predicted pose to normalise the features from the vote with respect to the object.

Next, each feature is compared with the training data using the Hash table Hᵢ constructed as explained with reference to FIG. 5.

The number of matches of features for a particular vote are calculated. Then the process determines if there are any further votes available in step S211. If further votes are available, the next vote is selected in step S213 and the process is repeated from step S205. Once all votes have been analysed, the vote with the highest number of matching features is selected in step S215 as the predicted pose and object.

In the methods of the above embodiments, the votes are selected by comparing the feature locations and not the feature descriptions, this exploits the geometry of the object as whole.

The above two methods have only used the feature locations. However, in a further embodiment, the rotations of the features is also considered. Returning to the collection of training data as described with reference to FIG. 5, the hash table is created in step S163. Each hash entry is the set of rotations of all normalised locations hashed to it.

When rotation is compared, the hash table will be operated in the same manner as described before, but each hash entry will contain a set of rotations.

When rotations are compared as described above, the on-line phase is similar to the on-line phase described with reference to FIG. 6. To avoid unnecessary repetition, like reference numerals will be used to denote like features.

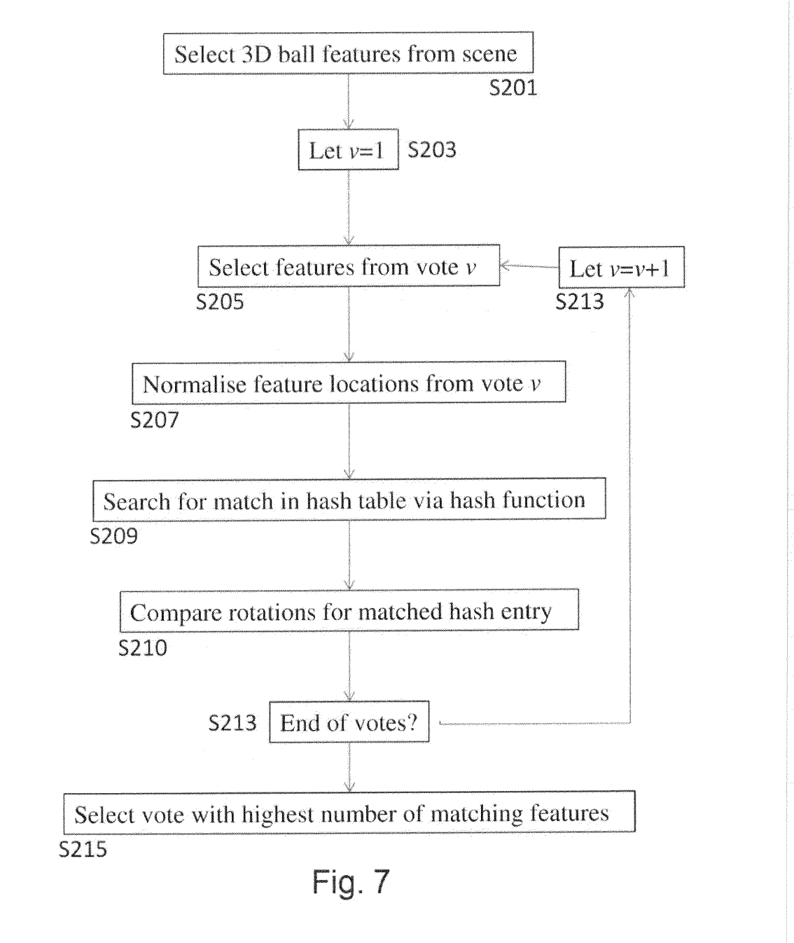

The process will proceed in the same manner as described with reference to FIG. 6 up to step S209. However, in FIG. 7, there is a further step S210 which takes place where the rotation of the feature from the scene is compared with the set of rotations located at the hash entry. The rotation of the feature from the scene is then compared with the set of rotations for the hash entry. If the hash entry matches the selected feature for scale, the match will be discounted if there is no match on rotation.

Then the process progresses to step S211 where the process checks to see if the last vote has been reached. If the last vote has not been reached then the process selects the next vote and loops back to step S205.

Once all votes have been processed, the vote is selected with the largest number of matching votes.

The above process can be achieved with the following algorithm:

Algorithm 2 Online phase: vote evaluation

| Parameters: hash tables H and scene feature locations S | |
|---|---|
| Input: vote = (object identity i, pose Y) | |
| 1: | w ← 0. |
| 2: | for all scene feature j: |
| 3: | X ← Y⁻¹Sⱼ. |
| 4: | Find hash entry V ← Hᵢ (h(X)). |
| 5: | if found: |
| 6: | w ← w + 4 − min_{Rεv} d(R, X_{R})². |
| 7: | Return w. |

Thus, the array of scene features, and in particular their rotations are compared, to the training data. Note, as explained above, the method does not involve any feature descriptions, as only pose is required. Therefore, the geometry of an object as a whole is exploited and not the geometry of local features.

The rotations can be compared using a number of different methods. In an embodiment a 3D generalisation of the 2D cosine distance is used.

A robust cosine-based distance between gradient orientations can be used for matching arrays of rotation features. Given an image Ii, the direction of the intensity gradient at each pixel value is recorded as rotation angle r_{i,j}, j=1, . . . , N, i.e. the j^{th} angle value of the i^{th} image. The square distance between two images, Iₐ and I_{b}, is provided by:

$${d ( {r}_{a} , {r}_{b} )}^{2} := 1 - {\sum }_{j = 1}^{N} \frac{cos ( {r}_{a , j} - {r}_{b , j} )}{N} , \qquad ( 8 )$$

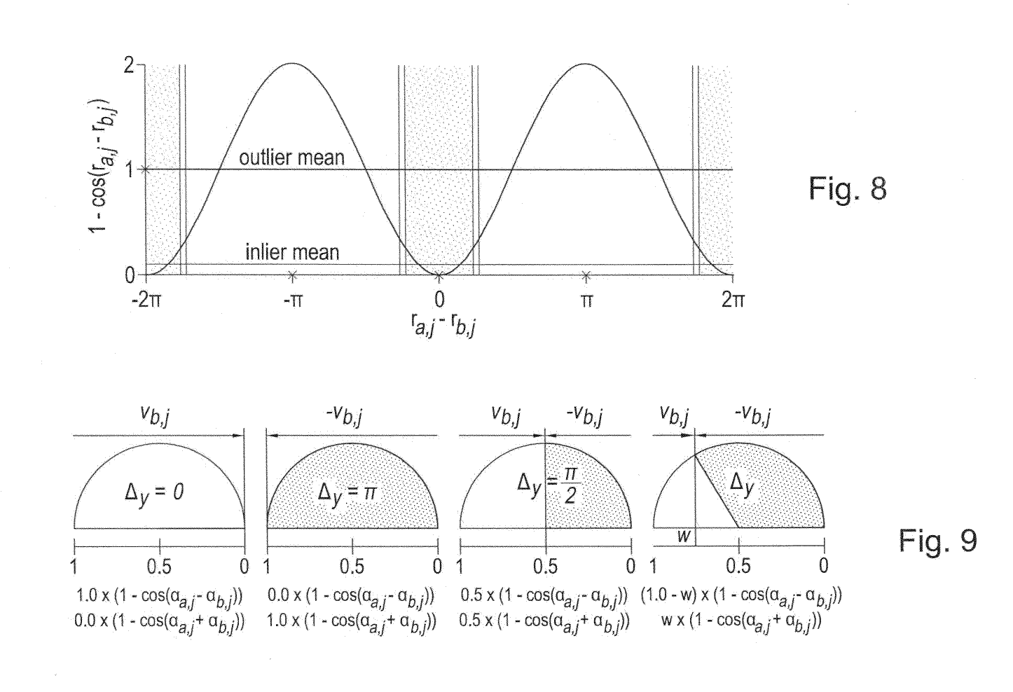

The distance function and its robust properties can be visualized as shown in FIG. 8. The advantages of this type of distance function stem from the sum of cosines. In particular for an uncorrelated area P, with random angle directions, the distance values are almost uniformly distributed, such that Σ_{j∈P}cos(r_{a,j}−r_{b,j})≈0 and the distance tends to 1. However, for highly correlated arrays of rotations, the distance is near 0. Thus, while inliers have more effect and pull the distance towards 0, outliers have less effect and shift the distance towards 1—not 2.

In 2D, rotation, r_{i,j} was solely provided by an angle αᵢⱼ. In 3D, it can be assumed that the rotations are described as an angle-axis pair r_{i,j}=(α_{i,j}, ν_{i,j})∈SO(3). In an embodiment, the following distance function can be used for comparing arrays of 3D rotations:

$${d ( {r}_{a} , {r}_{b} )}^{2} := 1 - {\sum }_{j = 1}^{N} ( \frac{1 - {υ}_{a , j} \cdot {υ}_{b , j}}{2} ) \frac{cos ( {α}_{a , j} - {α}_{b , j} )}{N} - {\sum }_{j = 1}^{N} ( \frac{1 + {υ}_{a , j} \cdot {υ}_{b , j}}{2} ) \frac{cos ( {α}_{a , j} - {α}_{b , j} )}{N} . \qquad ( 9 )$$

It should be noted that

$$\frac{1 + {υ}_{a , j} \cdot {υ}_{b , j}}{2} + \frac{1 - {υ}_{a , j} \cdot {υ}_{b , j}}{2} = 1 ,$$

i.e. both terms act as a weighting. The weight is carefully chosen to depend on the angle between the rotations' unit axes.

The special properties of the weight are shown in FIG. 9. Considering 2 rotations, rₐⱼ and r_{bj}. If both share the same axis νₐⱼ=ν_{bj}, the dot-product νₐⱼ·ν_{bj}=1 and the distance turns into its 2D counterpart in (1). In the case of opposing axes, νₐⱼ=−ν_{bj}, νₐⱼ·ν_{bj}=−1 and the sign of α_{bj} is flipped. Notice that (α_{bj}, −ν_{bj})=(−α_{bj}, νₐⱼ). Hence, again the problem is reduced to (1). A combination of both parts is employed when −1<νₐⱼ·ν_{bj}<1.

The proposed cosine-based distance in 3D can be thought of as comparing the strength of rotations. If rotations are considered “large” and “small” according to their angles, it seems sensible to favor similar angles. The robust properties of the above 3D distance function stem from the pretty evenly distributed distance count of random rotations. The mean of outliers is near the centre of the distance values, while similar rotations are close to 0. This corresponds to the robust properties of the cosine distance in 2D.

The above described 3D distance induces a new representation for 3D rotations, which allows for efficient and robust comparison. This will hereinafter be termed a full-angle quarternion (FAQ) representation.

The squared distance can be rewritten as follows:

$$\begin{matrix}{d ( {r}_{a} , {r}_{b} )}^{2} = 1 - {\sum }_{j = 1}^{N} \frac{cos {α}_{a , j} cos {α}_{b , j}}{N} - \\ {\sum }_{j = 1}^{N} \frac{( {υ}_{a , j} \cdot {υ}_{b , j} ) sin {α}_{a , j} sin {α}_{b , j}}{N} \\ = {\sum }_{j = 1}^{N} \frac{{( cos {α}_{a , j} - cos {α}_{b , j} )}^{2}}{2 N} + \\ {\sum }_{j = 1}^{N} \frac{{‖ {υ}_{a , j} sin {α}_{a , j} - sin {α}_{b , j} {υ}_{b , j} ‖}^{2}}{2 N} ( 11 ) \\ = \frac{1}{2 N} {\sum }_{j = 1}^{N} {‖ {q}_{a , j} - {q}_{b , j} ‖}^{2} , ( 12 )\end{matrix} \qquad ( 10 )$$

where qᵢⱼ is a unit quarternion given by:

q_{i,j}:=cos α_{i,j}+(iν_{i,j,1}+jν_{i,j,2}+kν_{i,j,3})sin α_{i,j}. (13)

The above equation defines the FAQ representation. Here, the trigonometric functions cos(•) and sin(•) are applied to the full angle αᵢⱼ instead of the half angle αᵢⱼ/2. Thus, each 3D rotation corresponds to exactly one unit quarternion under FAQ. In addition, the above equation shows that the new distance proposed above has the form of the Euclidean distance using the new FAQ representation.

The mean of 3D rotations under FAQ is global and easy to compute. Given a set of unit quaternions, the mean is computed simply by summing up the quaternions and dividing the result by its quaternion norm. The FAQ representation comes with a degenerate case as every 3D rotation by 180° maps to the same unit quaternion: q=(−1; 0; 0; 0).

The above new FAQ representation can be used to compare the rotation of the scene feature with the set of rotations at each Hash entry. Unlike the general case of robust matching of 3D rotations when both inputs can be corrupted, it can be assumed that the rotation of a training feature is usually an inlier, since the training data is often clean. Thus, the method mostly compares a rotation from the scene with an inlier. To utilize this fact, apart from using (equation 9), a left-invariant version of it is used:

d′(R,X_{R}):=d(I,R⁻¹X_{R}), (14)

where I is the 3-by-3 identity matrix, R is the rotation of a training feature, and X_{R} is a rotation from the scene.

$$\begin{matrix}\frac{1}{2} = \vert \vert R - {X}_{R} {\vert \vert}_{F}^{2} = {( 1 - cos α )}^{2} + {( sin α )}^{2} \\ = {( 1 - cos α )}^{2} + \vert \vert 0 - v sin α {\vert \vert}^{2} ( 16 ) \\ = \vert \vert faq ( I ) - faq ( {R}^{- 1} {X}_{R} ) {\vert \vert}^{2} \\ = {{d}^{′} ( R , {X}_{R} )}^{2} , ( 17 )\end{matrix} \qquad ( 15 )$$

where α and v are respectively the angle and axis of R⁻¹X_{R}, and faq(•) denotes the FAQ representation of a rotation matrix.

The above embodiment has compared rotations using the new FAQ representation described above. However, other embodiments can use alternative methods for comparing rotation. Most of these are Euclidean (and variants) under different representations of 3D rotations. The Euler angles distance is the Euclidean distance between Euler angles. L2-norms of differences of unit quaternions under the half-angle quarternion (HAQ) representation lead to the vectorial/extrinsic quaternion distance and the inverse cosine quaternion distance. Analysis of geodesics on SO(3) leads to intrinsic distances which are the L2-norm of rotation vectors (RV), i.e. the axis angle representation. The Euclidean distance in the embedding space [symbol] ⁹ of SO(3) induces the chordal/extrinsic distance between rotation matrices (RM).

In an embodiment, an extrinsic distance measure is used, e.g. Euclidean distance of embedding spaces, based on the HAQ and RM representations, due to their efficient closed-forms and their connections to efficient rotation means.

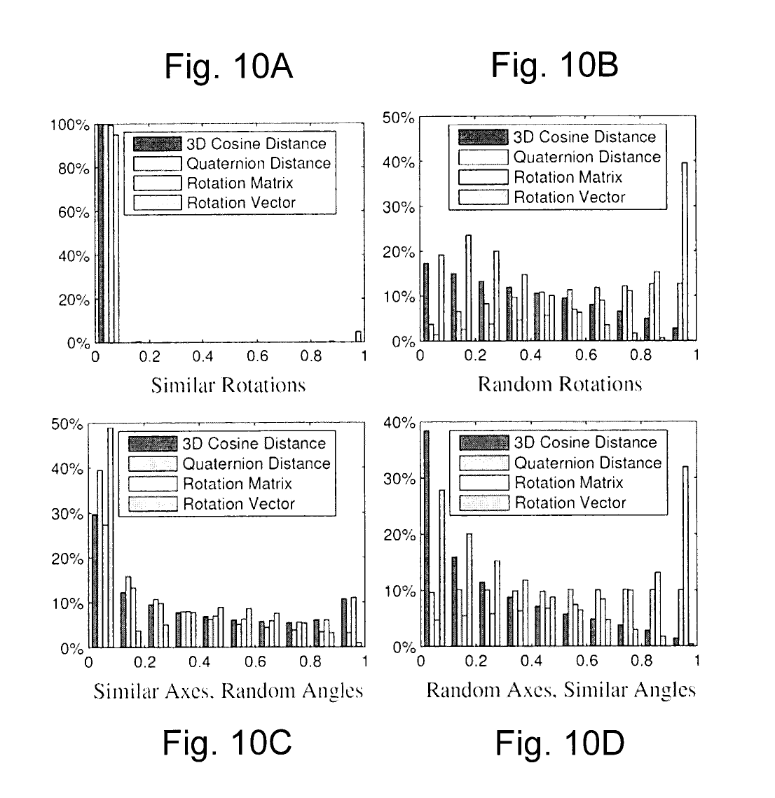

FIG. 10 compares the new 3D distance measure described above with the HAQ, RM and RV distances. When similar rotations are compared (FIG. 10(a)), the RV representation is sensitive to rotations with angles close to 180°, here the normalized distance may jump from near 0 to near 1. All other methods are able to identify close rotations successfully. When comparing random rotations (FIG. 10(b)), RM and RV strongly bias the results either towards small or large distances. The distance under HAQ and the 3D cosine-based distance, on the other hand, are more evenly distributed. The 3D cosine-based distance shows similar properties to the distance under RM when utilized for rotations with similar rotation axes (FIG. 10(c)). Here HAQ produces overall smaller distances. The distance under RV is quite unstable for this setup, as no real trend can be seen. However, when exposed to similar rotation angles (FIG. 10(d)), it behaves similarly to the 3D cosine-based distance. RM shows a bias towards large distances, while HAQ has an even distribution of distances.

The new cosine-based distance in 3D can be thought of as comparing the strength of rotations. If rotations are considered “large” and “small” according to their angles, it seems sensible to favour similar angles. The robust properties of the 3D cosine-based distance function stem from the pretty evenly distributed distance count of random rotations. In an embodiment, for the 3D cosine based distance, there is a a maximum distribution of 20% in a single bin.

The mean of outliers is near the centre of the distance values, while similar rotations are close to 0. This corresponds to the robust properties of the cosine distance in 2D.

The above embodiments have used a hash table to match features between the scene and the training data. However, in a further embodiment, a different method is used.

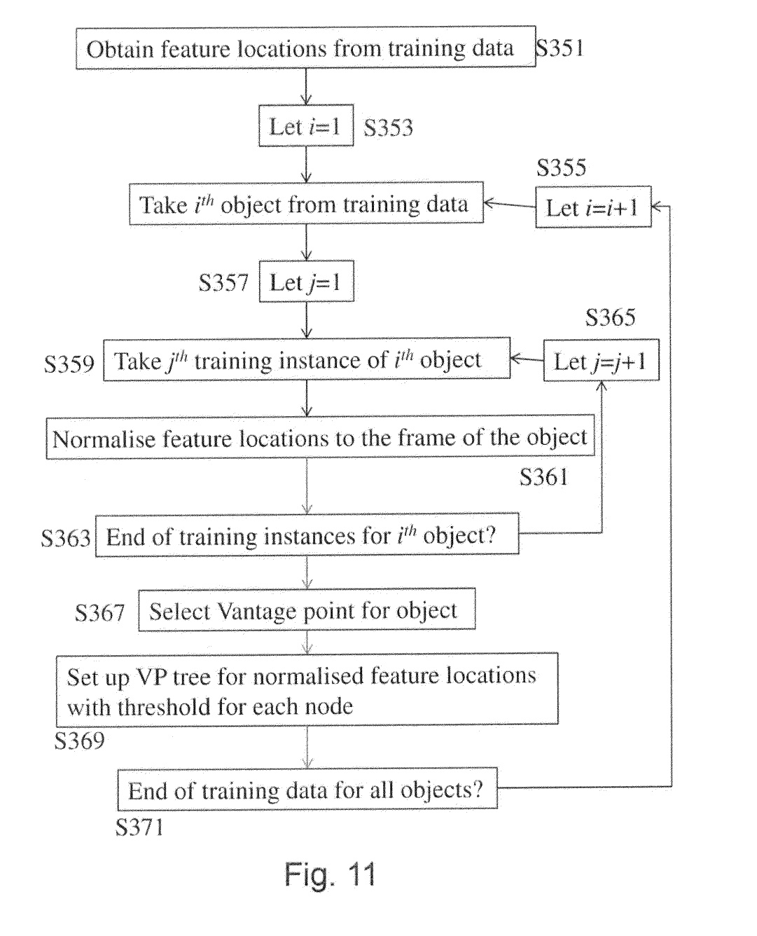

Here, a vantage point search tree is used as shown in FIG. 11. In the offline phase training data is collected for each object type to be recognized. In step S351, all feature locations that occur in the training data are collected. The features extracted from the training data and are processed for each object (i) and each training instance (j) of that object. In step S353 the object count (i) is set to 1 and processing of the i^{th} object starts in step S355. Next, the training instance count (j) for that object is set to 1 and processing of the j^{th} training instance begins in step S359.

Next, the selected features are normalized via left-multiplication with their corresponding object pose's inverse. This brings the features to be normalised to the object space in step S361.

In step S363, the process checks to see if all instances of an object have been processed. If not, the training instance count is incremented in step S365 and the features from the next training instance are processed. Once all of the training instances are processed, a search tree is constructed. In an embodiment, the search tree is a Vantage point search tree of the type which will be described with reference to FIG. 13.

In step S367, a vantage point is selected and a threshold C. The tree for an object is then constructed with respect to this vantage point. In an embodiment, the vantage point and threshold are chosen to generally divide the set of features from the training data into 2 groups. However, in other embodiments the vantage point is selected at random. The vantage point has a threshold C. The distance of each training feature from the vantage point is determined.

In an embodiment, a closed form solution is used for comparing the distance of a feature from the vantage point, the vantage point being expressed in the same terms as a feature. In one embodiment, the features are expressed as 3D balls which represent scale and translation of the features. If two balls x and y are given by x=(rₓ; cₓ) and y=(r_{y}; c_{y}) where rₓ; r_{y}>0 denote the radii and cₓ·c_{y}∈ [symbol] ³ denote the ball centers in 3D. The formula below compares x and y as a distance function:

$${d}_{1} ( x , y ) = {cosh}^{- 1} ( 1 + \frac{{( {r}_{x} - {r}_{y} )}^{2} + \vert \vert {c}_{x} - {c}_{y} {\vert \vert}^{2}}{2 {r}_{x} {r}_{y}} ) . \qquad ( 18 )$$

Where the function cosh( )is the hyperbolic cosine function. The distance is known in the literature as the Poincare distance.

In a further embodiment, the features are also expressed and compared in terms of rotation. If two balls x and y are associated with two 3D orientations, represented as two 3-by-3 rotation matrices Rₓ, R_{y}∈SO(3), they can be compared using the following distance function:

d₂(x,y)=\sqrt{α₁d₁(x,y)²+α₂∥Rₓ−R_{y}∥_{F}²,} (19)

where the second term α₂∥Rₓ−R_{y}∥_{F}² represents a distance function between two 3D orientations via the Frobenius norm, and coefficients α₁; α₂>0 pre defined by the user which enables making trade-offs between two distance functions. In practice, α₁=α₂=1 can be set to obtain good performance, but other values are also possible. Different distance measures can be used in equation (19), for example distance function between two 3D orientations via the Frobenius norm can be substituted by the distance of equation (9).

Depending on whether or not the features are to be compared using scale and transition or scale, translation and rotation, equation (18) or equation (19) will be used to calculate the distance. The tree is constructed from the training data and the tree is constructed as a binary search tree. Once the training data has been divided into 2 groups by selection of the vantage point and threshold, each of the 2 groups are then subdivided into a further 2 groups by selection of a suitable point and threshold for each group. The search tree is constructed until a training data cannot be divided further.

Once a search tree has been established for one object, the process moves to step S371 where a check is performed to see if there is training data available for further objects. If further training data is available, the process selecting the next object at step S373 and then repeats the process from step S359 until search trees have been constructed for each object in the training data.

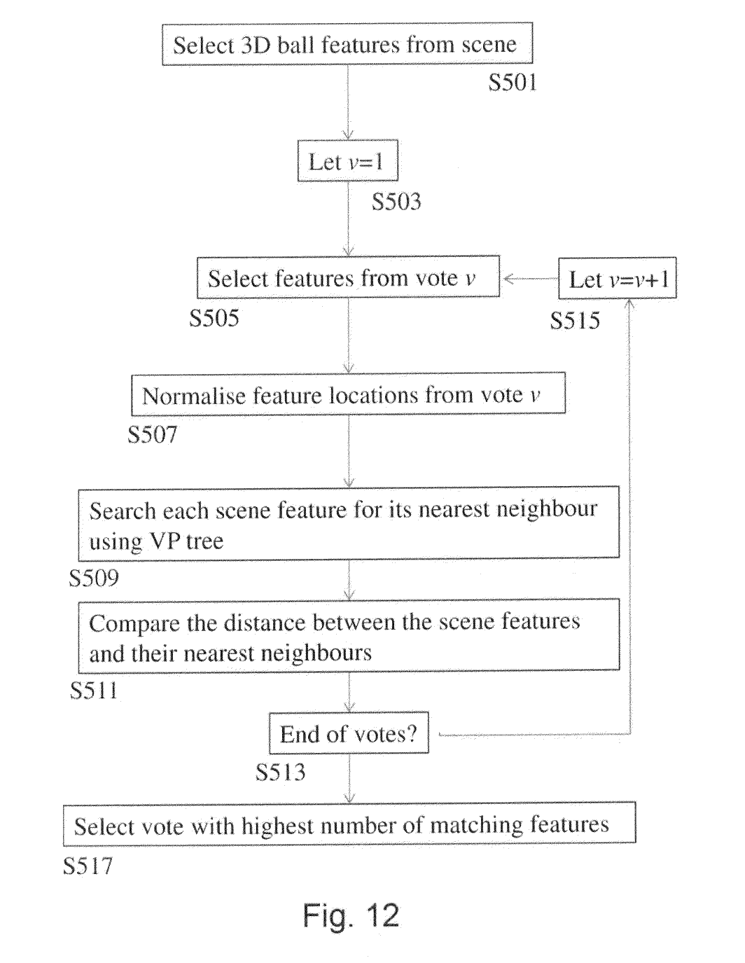

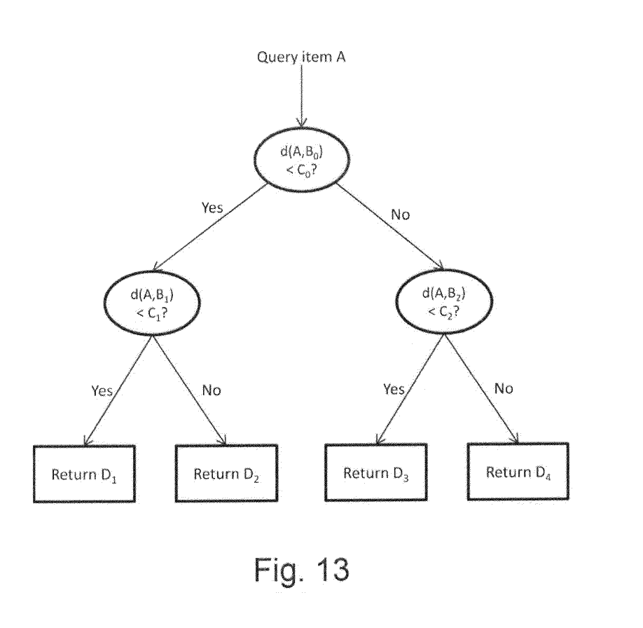

FIG. 12 is a flow diagram showing the on-line phase. In the same manner as described with reference to FIG. 6, in step S501, the search space is restricted to the 3D ball features are selected from the scene. Each ball feature is assigned to a vote which is prediction of the objects identity and pose. In step S503, the vote counter ν is assigned to 1. In step S505, features from vote ν are selected.

In step S507, the scene feature locations denoted by S for that vote are left multiplied with the inverse of the vote's predicted pose to normalise the features from the vote with respect to the object.

In step S509, the search tree is used to find the nearest neighbour for each of the scene features within a vote. The search is performed as shown in FIG. 13. Here, the scene feature is represented by “A”. Each internal tree node i has a feature Bᵢ and a threshold Cᵢ. Each leaf node i has an item Dᵢ. To find a nearest neighbour for a given feature A is done by comparing the distance between A and B, using either of equations (18) or (19) above. Eventually, a leaf node Dᵢ will be selected as the nearest neighbour.

In step S511, the distance between the scene feature and the selected nearest neighbour is compared with a threshold. If the distance is greater than the threshold then the nearest neighbour is not considered to be a match. If the distance is less than a threshold then a match is determined. The number of matches for each vote with an object are determined and the vote with the largest number of matches is determined to be the correct vote.

The above methods can be used in object recognition and registration.

In a first example, a plurality of training objects are provided. These may be objects represented as 3D CAD models or scanned from a 3D reconstruction method. The goal is to detect these objects in a scene where the scene is obtained by 3D reconstruction or by a laser scanner (or any other 3D sensors).

In this example, the test objects are a bearing, a block, bracket, car, cog, flange, knob, pipe and two types of piston. Here, training data in the form of point clouds of the objects were provided. If the objects were provided in the form of 3D CAD models, then the point cloud is simply the set of vertices in the CAD model.

Then point clouds were provided to the system in the form of a dataset consisting of 1000 test sets of votes, each computed from a point cloud containing a single rigid object, one of the 10 test objects.

The process explained with reference to FIGS. 5 and 7 was used. The method of FIG. 7 and 5 variants on this method were used. These methods differ in line 6 of alg. 2, where different weighting strategies corresponding to different distances are adopted as shown in table 1. Hashing-CNT was used as the baseline method for finding σₛ and σₜ. Hashing-CNT is the name given to the method described with reference to FIG. 6 where the comparison is purely based on matching dilatations without matching rotation. Table 1 shows weighting strategies for different methods. Functions HAQ(•), RV(•), FAQ(•) are representations of a 3D rotation matrix.

TABLE 1

| Method name | Weight |
|---|---|
| Hashing-CNT | 1 |
| Hashing-HAQ | 4 − min_{RεV} ∥haq(R) − haq(X_{R})∥² |
| Hashing-RV | 4π² − min_{RεV} ∥rv(R) − rv(X_{R})∥² |
| Hashing-LI-RV | π² − min_{RεV} ∥rv(R⁻¹X_{R})∥² |
| Hashing-FAQ | 4 − min_{RεV} ∥faq(R) − faq(X_{R})∥² |
| Hashing-LI-FAQ | 4 − min_{RεV} ∥faq(I) − faq(R⁻¹X_{R})∥² |

To find the best values for σₛ and σₜ, a grid search methodology was adopted using leave-one-out cross validation. The recognition rate was maximised, followed by the registration rate. The best result for hashing-CNT was found at (σₛ; σₜ)=(0:111; 0:92) where the recognition rate is 100% and the registration rate is 86.7% (table 2, row 2).

Cross validation over the other 5 variants was run using the same values for (σₛ; σᵢ), so that their results can be compared (see table 2). In all cases, 100% recognition rates were obtained. Hashing-LI-FAQ gave the best registration rate, followed by hashing-HAQ, hashing-LI-RV, and hashing-FAQ, and then by hashing-RV. The left-invariant distances of RV and FAQ outperformed their non-invariant counterparts respectively.

The results are shown in table 2

| | registration rate per object (%) | | | | | | | | | | | recognition | time |
|---|---|---|---|---|---|---|---|---|---|---|---|---|---|
| Method name | bearing | block | bracket | car | cog | flange | knob | pipe | piston 1 | piston 2 | total | rate (%) | (s) |
| Min-entropy [36] | 83 | 20 | 98 | 91 | 100 | 86 | 91 | 89 | 54 | 84 | 79.6 | 98.5 | 0.214 |
| Hashing-CNT | 85 | 31 | 100 | 97 | 100 | 95 | 99 | 92 | 71 | 97 | 86.7 | 100 | 0.092 |
| Hashing-HAQ | 91 | 29 | 100 | 95 | 100 | 94 | 99 | 90 | 83 | 96 | 87.7 | 100 | 0.103 |
| Hashing -RV | 92 | 23 | 100 | 94 | 100 | 89 | 100 | 89 | 81 | 94 | 87.3 | 100 | 0.117 |
| Hashing-LI-RV | 92 | 28 | 100 | 95 | 100 | 94 | 99 | 90 | 83 | 96 | 87.7 | 100 | 0.106 |
| Hashing-FAQ | 93 | 27 | 100 | 95 | 100 | 92 | 99 | 89 | 84 | 98 | 87.7 | 100 | 0.097 |
| Hashing-LI-FAQ | 94 | 26 | 100 | 95 | 100 | 97 | 99 | 90 | 82 | 96 | 87.9 | 100 | 0.095 |

In a further example, the above processes are used for point cloud registration. Here, there is a point cloud representing the scene (e.g. a room) and another point cloud representing an object of interest (e.g. a chair). Both point clouds can be obtained from a laser scanner or other 3D sensors.

The task is to register the object point cloud to the scene point cloud (e.g. finding where the chair is in the room). The solution to this task is to apply the feature detector to both point clouds and, then the above described recognition and registration is used to find the pose of the object (the chair).

While certain embodiments have been described, these embodiments have been presented by way of example only, and are not intended to limit the scope of the inventions. Indeed the novel methods and systems described herein may be embodied in a variety of other forms; furthermore, various omissions, substitutions and changes in the form of methods and systems described herein may be made without departing from the spirit of the inventions. The accompanying claims and their equivalents are intended to cover such forms of modifications as would fall within the scope and spirit of the inventions.

1. A method for comparing a plurality of objects, the method comprising representing at least one feature of each object as a 3D ball representation, the radius of each ball representing the scale of the feature in the with respect to the frame of the object, the position of each ball representing the translation the feature in the frame of the object, the method further comprising comparing the objects by comparing the scale and translation as represented by the 3D balls to determine similarity between objects and their poses.

2. A method according to claim 1, wherein the 3D ball representations further comprise information about the rotation of the feature with respect to the frame of the object and wherein comparing the object comprises comparing the scale, translation and rotation as defined by the 3D ball representations.

3. A method according to claim 1, wherein comparing the scale and translation comprises comparing a feature of a first object with a feature of a second object to be compared with the first object using a hash table, said hash table comprising entries relating to the scale and translation of the features of the second object hashed using a hash function relating to the scale and translation components, the method further comprising searching the hash table to obtain a match of a feature from the first object with that of the second object.

4. A method according to claim 3, wherein the hash function is described by:
h(X):=η∘Φ(X_{D}).
where h(X) is the hash function of direct similarity X,
$${X}_{D} := [ \begin{matrix}{X}_{s} & {X}_{t} \\ 0 & 1\end{matrix} ]$$
is the dilatation part of a direct similarity X, where Xₛ is the scale part of direct similarity X and Xₜ is the translation part of direct similarity X,
Φ(X_{D}):=(lnXₛ,Xₜ^{T}/Xₛ)^{T}; and
η is a quantizer.

5. A method according to claim 3, wherein the hash table comprises entries for all rotations for each scale and translation component.

6. A method according to claim 5, wherein the 3D ball representations further comprise information about the rotation of the feature with respect to the frame of the object and wherein comparing the object comprises comparing the scale, translation and rotation as defined by the 3D ball representations, the method further comprising comparing the rotations stored in each hash table entry when a match has been achieved for scale and translation components, to compare the rotations of the feature of the first object with that of the second object.

7. A method according to claim 6, wherein the rotations are compared using a cosine based distance in 3D.

8. A method according to claim 7, wherein the cosine based distance is expressed as:
$${d ( {r}_{a} , {r}_{b} )}^{2} := 1 - {\sum }_{j = 1}^{N} ( \frac{1 - {υ}_{a , j} \cdot {υ}_{b , j}}{2} ) \frac{cos ( {α}_{a , j} - {α}_{b , j} )}{N} - {\sum }_{j = 1}^{N} ( \frac{1 + {υ}_{a , j} \cdot {υ}_{b , j}}{2} ) \frac{cos ( {α}_{a , j} - {α}_{b , j} )}{N} .$$
where rₐ=(νₐ, αₐ) and r_{b}=(ν_{b}, α_{b}) are arrays for 3D rotations represented in the axis-angle representation. νₐⱼ and αₐⱼ, respectively denote the rotation axis and the rotation angle of the j^{th} component of the array rₐ. ν_{bj} and α_{bj}, respectively denote the rotation axis and the rotation angle of the j^{th} component of the array r_{b}.

9. A method according to claim 1, wherein comparing the scale and translation comprises comparing a feature of a first object with a feature of a second object to be compared with the first object using a search tree, said search tree comprising entries representing the scale and translation components of features in the second object, the scale and translation components being compared using a closed-form formulae.

10. A method according to claim 9, wherein the search tree is used to locate nearest neighbours between the features of the first object and the second object.

11. A method according to claim 9, wherein the scale and translation components are compared by measuring the Poincare distance between the two features.

12. A method according to claim 11, wherein the distance measure is expressed as:
$${d}_{1} ( x , y ) = {cosh}^{- 1} ( 1 + \frac{{( {r}_{x} - {r}_{y} )}^{2} + \vert \vert {c}_{x} - {c}_{y} {\vert \vert}^{2}}{2 {r}_{x} {r}_{y}} ) , \qquad ( 18 )$$
Where d₁(x,y) represents the distance between two balls x and y that are represented by x=(rₓ; cₓ) and y=(r_{y}; c_{y}) where rₓ; r_{y}>0 denote the radii, cₓ, c_{y}∈ [symbol] ³ denote the ball centers in 3D and cosh( )is the hyperbolic cosine function.

13. A method according to claim 9, wherein the 3D ball representations further comprise information about the rotation of the feature with respect to the frame of the object and wherein comparing the object comprises comparing the scale, translation and rotation as defined by the 3D ball representations using the formulae:
$${d}_{1} ( x , y ) = \sqrt{{a}_{1} {{d}_{1} ( x , y )}^{2} + {a}_{2} \vert \vert {R}_{x} - {R}_{y} {\vert \vert}_{F}^{2}} , \\ where \\ {d}_{1} ( x , y ) = {cosh}^{- 1} ( 1 + \frac{{( {r}_{x} - {r}_{y} )}^{2} + \vert \vert {c}_{x} - {c}_{y} {\vert \vert}^{2}}{2 {r}_{x} {r}_{y}} ) , \qquad ( 18 )$$
and d₁(x,y) represents the distance between two balls x and y that are represented by x=(rₓ; cₓ) and y=(r_{y}; c_{y}) where rₓ; r_{y}>0 denote the radii, cₓ, c_{y}∈ [symbol] ³ denote the ball centers in 3D and cosh( )is the hyperbolic cosine function, and the two balls x and y are associated with two 3D orientations, represented as two 3-by-3 rotation matrices Rₓ, R_{y}∈SO(3), the term α₂∥Rₓ−R_{y}∥_{F}² represents a distance function between two 3D orientations via the Frobenius norm, and coefficients α₁; α₂>0.

14. A method according to claim 9, wherein the 3D ball representations further comprise information about the rotation of the feature with respect to the frame of the object and wherein comparing the object comprises comparing the scale, translation and rotation as defined by the 3D ball representations using the formulae:
$${d}_{3} ( x , y ) = \sqrt{{a}_{1} {{d}_{1} ( x , y )}^{2} + {a}_{2} {d ( x , y )}^{2}}$$
$$where$$
$${d}_{1} ( x , y ) = {cosh}^{- 1} ( 1 + \frac{{( {r}_{x} - {r}_{y} )}^{2} + \vert \vert {c}_{x} - {c}_{y} {\vert \vert}^{2}}{2 {r}_{x} {r}_{y}} ) ,$$
and d₁(x,y) represents the distance between two balls x and y that are represented by x=(rₓ; cₓ) and y=(r_{y}; c_{y}) where rₓ; r_{y}>0 denote the radii, cₓ, c_{y}∈ [symbol] ³ denote the ball centers in 3D and cosh( )is the hyperbolic cosine function, and the two balls x and y are associated with two 3D orientations, represented as two 3-by-3 rotation matrices Rₓ, R_{y}∈SO(3), the term, d(x,y)² represents a distance function between two 3D orientations via a cosine based distance, and coefficients α₁; α₂>0.

15. A method for object recognition, the method comprising:
receiving a plurality of votes, wherein each vote corresponds to a prediction of an objects pose and position;
for each vote, assigning 3D ball representations to features of the object, wherein the radius of each ball represents the scale of the feature in the with respect to the frame of the object, the position of each ball representing the translation the feature in the frame of the object,
determining the vote that provides the best match by comparing the features as represented by the 3D ball representations for each vote with a database of 3D representations of features for a plurality of objects and poses, wherein comparing the features comprises comparing the scale and translation as represented by the 3D balls; and
selecting the vote with the greatest number of features that match an object and pose in said database.

16. A method according to claim 15, wherein the 3D ball representations assigned to the votes and the objects and poses in the database further comprise information about the rotation of the feature with respect to the frame of the object and wherein determining the vote comprises comparing the scale, translation and rotation as defined by the 3D ball representations.

17. A method according to claim 15, wherein receiving a plurality of votes comprises:
obtaining 3D image data of an object;
identifying features of said object and assigning a description to each feature, wherein each description comprises an indication of the characteristics of the feature to which it relates;
comparing said features with a database of objects, wherein said database of objects comprises descriptions of features of known objects; and
generating votes by selecting objects whose features match at least one feature identified from the 3D image data.

18. A method of registering an object in a scene, the method comprising:
obtaining 3D data of the object to be registered;
obtaining 3D data of the scene;
extracting features from the object to be registered and extracting features from the scene to determine a plurality of votes, wherein each vote corresponds to a prediction of an object's pose and position in the scene, and comparing the object to be registered with the votes using a method in accordance with claim 1 to identify the presence and pose of the object to be registered.

19. A computer readable medium carrying processor executable instructions which when executed on a processor cause the processor to carry out a method according to claim 1.

20. An apparatus for comparing a plurality of objects,
the apparatus comprising a memory configured to store 3D data of the objects comprising at least one feature of each object as a 3D ball representation, the radius of each ball representing the scale of the feature in the with respect to the frame of the object, the position of each ball representing the translation the feature in the frame of the object,
the apparatus further comprising a processor configured to compare the objects
by comparing the scale and translation as represented by the 3D balls to determine similarity between objects and their poses.
